(19) United States
(12) Patent Application Publication
(10) Pub. No.: US 2026/0147313 A1
(43) Pub. Date: May 28, 2026

(54) PRINT TO REGISTER MULTI-PATTERN HOLOGRAPHY

(71) Applicant: Hazen Paper Company, Holyoke, MA (US)

(72) Inventors: John HAZEN, South Hadley, MA (US); Don HAVOURD, Ellington, CT (US)

(73) Assignee: Hazen Paper Company, Holyoke, MA (US)

(21) Appl. No.: 19/400,682

(22) Filed: Nov. 25, 2025

Related U.S. Application Data
(60) Provisional application No. 63/725,046, filed on Nov. 26, 2024.

(51) Int. Cl. G03H 1/00; G03H 1/02

(52) U.S. Cl. CPC G03H 1/0005; G03H 1/0256; G03H 1/0272; G03H 1/0276; G03H 2001/0094; G03H 2001/0296; G03H 2210/20; G03H 2210/562

(57) ABSTRACT

A master sheet includes a substrate and a metallized layer adhered to the substrate. The metallized layer has a plurality of different holographic patterns located at different locations on the substrate corresponding to locations of cards configured to be cut from the substrate.

### CROSS-REFERENCE TO RELATED APPLICATIONS

This application claims priority to U.S. Provisional Application Ser. No. 63/725,046 filed on Nov. 26, 2024, which is incorporated herein by reference in its entirety.

### FIELD OF THE INVENTION

This invention relates generally to trading cards, for example multi-pattern holographic cards, and systems and methods for manufacturing holographic trading cards.

### BACKGROUND

Cards such as, for example, trading cards, gift cards, tickets, lottery tickets, and the like, are generally designed to be visually appealing to a potential purchaser. Over the years, cards have become more striking and intricate in their graphics, effects, and the like, and often include holographic images to further increase their uniqueness, marketability and desirability.

Typically, card printers and converters print a series of individual trading cards on a “wallpaper” patterned holographic sheet. A wallpaper pattern is defined as a repeating and symmetrical overall pattern across the sheet that remains the same, or very similar, on every card. The patterned holographic sheet is divided into a grid, with each grid cell defining an individual trading card. In the case of sports trading cards, each grid cell is printed, typically using offset printing, with a player image, various graphics, statistics and other design elements. After these cards are printed and die cut, they are manually stacked and placed into card decks and “drop” machines.

For most holographic cards, there are many, sometimes as great as 50 to 100, different holographic master wallpaper sheet designs/layouts used in order to provide variety in card appearance/effect. In the trading card industry, for example, a card manufacturer may utilize 50 or more master sheet designs/layouts for each collection. This requires starting, stopping, changing artwork and print plates, etc. As indicated above, currently, these master sheets only have one holographic pattern over the entire sheet. These sheets are printed on an offset press that does not allow for variable data or programming. As such, the collation process, the order, and drop rate of cards, are all manual. Often time, there are employees picking individual cards from stacks (e.g., rare, high value cards) and placing them into decks manually. Indeed, cards must be carefully combined from a large number of master sheets in order to obtain card packages and sets having a desired player variability and card rarity.

As will be readily appreciated, this is a hugely inefficient process. Due to the high value of these limited-edition cards, some of which sell on resale markets for large sums, the supervision and security for the manual placement of these cards into decks is costly and time consuming. Furthermore, there are many manual or human errors that result in significant issues from a business and/or public relations standing point, for example multiple “1 of 1” limited edition cards going to market.

Further, as described above, cards may typically be printed on a holographic sheet having a single holographic pattern, which requires that many different sheets to be printed with various cards and the cards must be cut from the sheet and collated in order to provide variety within a single card pack or box.

In view of the above, there is a need for a more efficient system and method of manufacturing cards and, in particular, trading cards.

### SUMMARY OF THE INVENTION

It is an object of the present invention to provide a system and method of manufacturing cards such as, for example, trading cards.

It is another object of the present invention to provide a system and method of manufacturing trading cards that integrates and collaborates with other systems in the card collation process.

It is another object of the present invention to provide a system and method for customizing trading cards.

It is another object of the present invention to provide a system and method for customizing a holographic pattern per each card collection's master layout.

These and other objects are achieved by the present invention.

According to an embodiment of the present invention, a master sheet is provided and includes a substrate and a metallized layer adhered to the substrate. The metallized layer has a plurality of different holographic patterns located at different locations on the substrate corresponding to locations of cards configured to be cut from the substrate.

According to another embodiment of the invention, a method of manufacturing a master sheet is provided and includes the steps of adhering a metal layer to a substrate, the metal layer including a first holographic pattern defining a first card, and a second holographic pattern defining a second card, printing a first image over the first holographic pattern, and printing a second image over the second holographic pattern.

According to yet another embodiment of the invention, a method of manufacturing trading cards includes the steps of providing a master sheet having a plurality of card positions arranged in a plurality of rows and a plurality of columns, at least one of the card positions having a different holographic pattern than the holographic pattern of another card position of the plurality of card positions, printing an image on each card position of the plurality of card positions, and cutting the master sheet at the boundaries of each card position to form a plurality of trading cards.

### BRIEF DESCRIPTION OF THE DRAWINGS

FIG. 1 is a graphical illustration of prior art wallpaper style holographic sheet with registered images.

FIG. 2 shows a card layout with different holographic patterns, according to one embodiment of the present invention.

### DETAILED DESCRIPTION OF THE PREFERRED EMBODIMENT

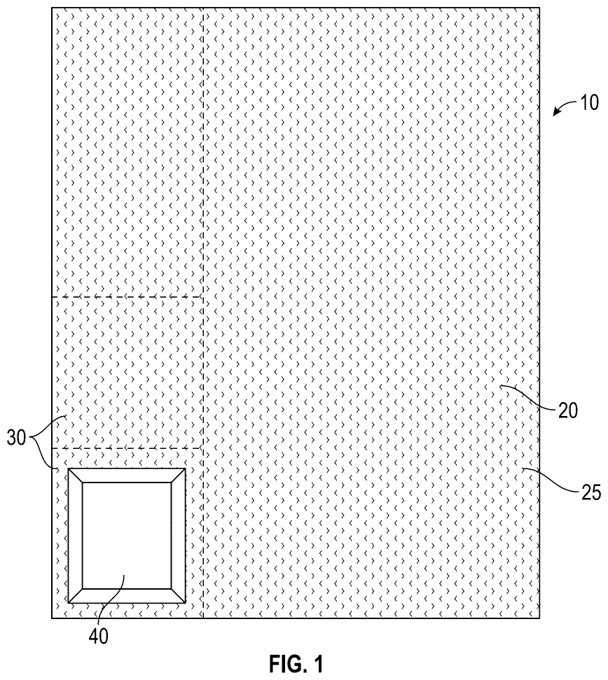

As discussed, above, and with reference to FIG. 1, known methods of generating holographic images for use with game cards, such as scratch-off lottery cards, involve the application of a wallpaper style holographic pattern to a paper substrate. The application of such a pattern is usually accomplished through a transfer lamination process in which a metallized film containing the holographic pattern is bonded to a substrate, cured and the stripped away to leave the metallized layer containing the holographic pattern on the substrate.

As shown therein, a relatively large sheet 10 that contains enough substrate material to yield multiple individual cards 30 is transfer laminated to leave a metallization, coating and/or PET having a holographic pattern on the substrate. The wallpaper style holographic pattern 20 includes repeated two-dimensional design elements 25 which create a wallpaper pattern that is present on each individual card 30. Score lines, perforations and the like may be used to delineate individual cards 30, if desired.

Once the metallized film having the holographic pattern 20 has been applied to the substrate (e.g., using transfer lamination or other processes known in the art), a print-receptive coating may be applied atop the metallized film, and the other design elements 40, e.g., the graphics, images, etc., are printed over the wallpaper holographic pattern 20 to result in a completed card. For example, for sports cards, images of the players may be printed on each card. The completed cards are then cut from the sheet 10. Various cards from different master sheets are then manually collated and packaged for sale. As stated above, the use of a wallpaper holographic pattern (i.e., a single, repeating pattern on the entire sheet 10) constrains the design and collation of cards as every card on a sheet has substantially the same holographic pattern.

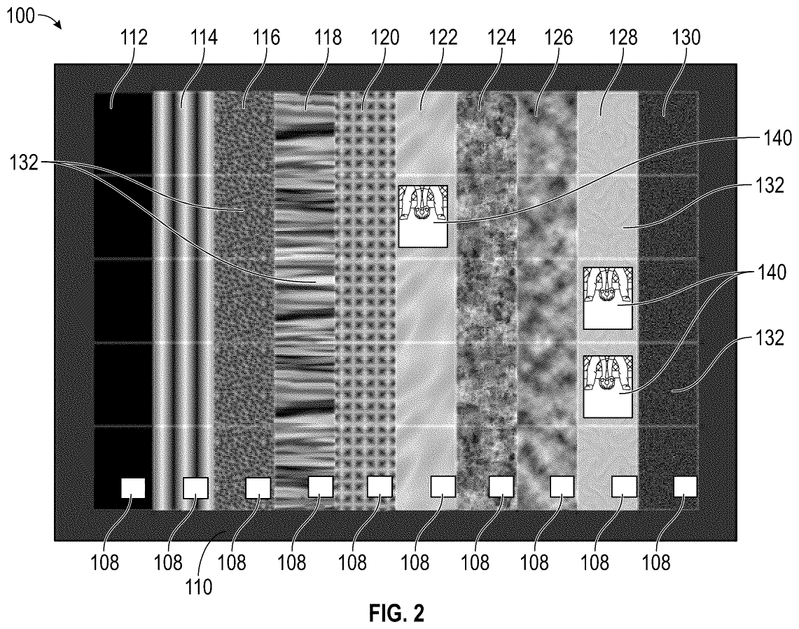

With reference to FIG. 2, a system and method for print-to-register multi-patten holography according to an embodiment of the present invention, suitable for use in the manufacture of, for example, trading cards, is illustrated. In particular, FIG. 2 illustrates a master sheet 100 (also referred to herein as master card layout 100) having a substrate 110 with a plurality of different holographic patterns 112, 114, 116, 118, 120, 122, 124, 126, 128 and 130. As shown therein, the master card layout 100 may be a 50-card layout with 10 different holographic patterns. For example, the card layout 100 may have ten columns, each with a different holographic pattern 112, 114, 116, 118, 120, 122, 124, 126, 128 and 130 in each column (with 5 card positions 132 in each column). As understood by one of ordinary skill in the art, the card layout may include a different number of individual cards, for example more or less than 50, and may include a different number of holographic patterns, for example more or less than 10. In an embodiment, each card position 132 may have a different holographic pattern. The location and spacing of the holographic patterns can vary depending on the desired look and/or number of cards being produced. For an example, in an embodiment, the master sheet may comprise 50 or more cards, each having a different holographic pattern. In another embodiment, the master sheet may comprise 100 cards, each having a different holographic pattern.

In an embodiment, the metallized layer having the holographic patterns may be applied to the substrate 110 as disclosed above to form the master sheet 100. Moreover, the various holographic patterns may be formed in the manner disclosed in U.S. Pat. Nos. 9,952,656 and/or 10,088,801, both of which are hereby incorporated by reference herein in their entireties. It is contemplated that the metallized layer with holographic patterns may be applied to the substrate 110 by any means known in the art. Moreover, rather than, or in addition to, having holographic patterns, the cards may have a variety of other patterns, designs, indicia, etc., formed by a variety of means.

As alluded to above, in one embodiment, after the metallized layer is applied to the substrate 110 in the manner described above, a digital print receptive coating may be applied to the metallized layer so that various images 140, text and the like can be printed on each card. In an embodiment, the text, images or other design elements can be registered at a certain position on each card and/or in alignment with certain holographic elements, as disclosed in U.S. Pat. No. 8,801,043, which is hereby incorporated by reference in its entirety.

In one embodiment, the master sheet 100 is formed by adhering a metallized film having a plurality of different holographic patterns 112, 114, 116, 118, 120, 122, 124, 126, 128 and 130 to the substrate, and then applying a print receptive coating over the metallized film. Alternatively, the print receptive coating may be applied first to a transfer film, and then the metallized film applied over the print receptive coating. The film (with print receptive coating and metallized layer) is then bonded to the substrate 110 and then the film is stripped, leaving the metallized layer and print receptive coating atop the substrate. This method is more clearly disclosed in U.S. Pat. No. 10,807,399, which is hereby incorporated by reference herein in its entirety. In such embodiment, the different holographic images/patterns are embossed into the print receptive coating, which is then transferred via the transfer metallization process (essentially the metal coating holographically embossed, then metallized, to become a part of the complete transfer metallization structure). In either case, this master sheet can then be shipped to card manufacturers/sellers for printing of the desired images, text and/or design elements on each card.

In particular, each card can on the master sheet can be unique, and can change per sheet. This allows a level of flexibility heretofore not seen in the art with traditional offset presses, and allows customers to program different card layouts for digital printing. The present invention thus allows customers to program multiple collections or parallels at one time without having to change to different holographic master sheets. As used herein, “collection” is a card series of a specific sport (e.g., baseball, soccer, basketball, football, hockey, etc.) and may include, for example. 50, 100 or more cards. As used herein, a “parallel” is a special version of a base trading card that shares the same photo and card number but has a different design, such as a different color, finish, or pattern. This results in a huge savings in throughput. Moreover, because digital printing can use variable data and change card layouts immediately, customers can algorithmically program the layouts to align with automated collation. For example, customers can program the high value cards in a certain location that will automatically hit their pre-selected ‘drop rates’ per card deck. This is in contrast to existing methods which require manual labor, are prone to human error risk, and which take an incredible amount of time to manually drop rare cards into decks. For example, in one embodiment, every 100^{th} sheet may contain a specific rare card, e.g., a Tom Brady rookie card, placed in a certain location that drops accordingly as a rare card into a deck.

In one embodiment, multiple collections or parallels can be printed on a single master sheet without needing to change sheets. For example, in an embodiment, the master sheet may have a single, rare holographic element or other design, and the rare card may be printed atop this rare holographic element. This obviates the need to change to a different master sheet to create the rare holographic element/rare card.

The present invention thus provides for a master sheet having multiple different holographic patterns, printed in register. The present invention contemplates that this method can be utilized to create trading cards such as sports cards and the like, although the present invention is not intended to be so limited in this regard. In particular, it is contemplated that the method disclosed herein can also be utilized to create other types of cards, such as playing cards, gift cards, and the like.

As disclosed above, this ‘multi-pattern’ customization on one master sheet allows for the trading card and other card brands to algorithmically program player/card/collection assignments to a particular holographic pattern, as well as drop rates into card packs/collation. This enhancement automates the collation process, eliminates the needs for human intervention, eliminates sorting errors, and eliminates manual human bottlenecks (and thus enhances throughput). The benefit to this technology is that it allows for algorithmic collation (packing in particular order) of the cards and streamlines production for the high value (holographic) cards.

In an embodiment, a controller may be programed for the entire master sheet/card layout to print, cut, and collate the cards automatically, without the need for any human selection or input. As such, the process may be automated which may increase efficiency and output, while reducing errors.

In one example, the controller may be programed based on the master sheet or the trading card brands input to automatically assign, based on player/card/collection, a particular holographic pattern and drop rates into card packs/collation. The controller may be programed using a predetermined algorithm or based on a changing algorithm, for example based on artificial intelligence and/or machine learning.

In one example, the master sheet 100 may include markers 108 on each card 132. The markers 108 may be at a fixed distance from the specific holographic pattern 112, 114, 116, 118, 120, 122, 124, 126, 128 and 130 and may assist the printer in printing in register with the specific holographic pattern 112, 114, 116, 118, 120, 122, 124, 126, 128 and 130. The markers 108 are generally configured with one marker per holographic pattern 112, 114, 116, 118, 120, 122, 124, 126, 128 and 130, or one marker per desired card 132. It may be possible, however, to use more than (or fewer than) one marker per pattern and/or card. Moreover, the markers 108 are depicted in a specific shape but, as will be appreciated, other markers may be employed.

The markers 108 may be scanned or read by an optical sensor that is operatively coupled with a printer. In operation, the sensor shines a beam of light onto the paper and assesses the contrasting reflectivity at predetermined positions on the sheet to detect the position of the holographic patterns on the substrate. The markers 108 allow printers to locate and print images in register with holographic patterns present on the substrate. This allows for a greater range of potential card designs and increases marketability and sales of such cards.

As will be appreciated, digital print allows for algorithmic changes to print varied designs (players, collections, athletes) immediately and instantaneously on a sheet-by-sheet basis. This also allows for serialization of cards. Serialization of cards may reduce errors, for example printing too many copies of a limited-edition card. With traditional print methods, the athletes printed would remain static throughout the print run, and then are manually collated by hand afterword. However, with the digital printing, the accuracy, efficiency, and speed of the process are greatly enhanced. In an embodiment, card packs or boxes may be printed on an individual basis. For example, the first row (containing, for example, 10 cards) may comprise the cards of a first card package, the second row may comprise the cards of a second package, and so on. In this respect, the composition of each card package and/or each box may be determined and customized prior to printing. In this respect, collation essentially takes place prior to cutting the cards from the master sheet, and there is no need to sort and collate cards after cutting in conformance with desired drop rates, etc., as this has all been determined at the master sheet layout stage.

As will be appreciated therefore, the system and method of the present invention allows the entire collection printing process to be fully automated. For example, a small number of different holographic master sheets may be created with a small number of ‘rare’ holographic patterns on certain master sheets (e.g., third column, 4^{th} row, every 5^{th} master sheet). The entire master sheet layout may be designed and loaded into a software program with, for example, a star athlete programmed for printing on the rare card position (the third column, 4^{th} row, every 5^{th} master sheet). Indeed, each card package or card box can be preprogrammed so that a card manufacturer can print, cut, and package the collection (with predetermined hit or drop rates) without any, or very limited, human intervention. Moreover, in one embodiment, each card position may be designed with a particular hologram and a particular player image, providing a level of customization, control and automation heretofore not seen in the art.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of this disclosure.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the embodiments described herein are intended to define the parameters of the inventive subject matter, they are by no means limiting and are example embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “comprises,” “including,” “includes,” “having,” or “has” an element or a plurality of elements having a particular property may include additional such elements not having that property.

This written description uses examples to disclose several embodiments of the invention, including the best mode, and also to enable one of ordinary skill in the art to practice the embodiments of invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A master sheet, comprising:
a substrate having a plurality of card positions; and
a plurality of different holographic patterns at different locations on the substrate.

2. The master sheet of claim 1, wherein:
the plurality of card positions define a plurality of rows, and a plurality of columns;
wherein the plurality of different holographic patterns include at least a first holographic pattern in one of a first row of the plurality of rows or a first column of the plurality of columns, and a second holographic pattern in one of a second row of the plurality of rows or a second column of the plurality of columns;
wherein the first holographic pattern is different from the second holographic pattern.

3. The master sheet of claim 1, wherein:
each card position includes a different holographic pattern of the plurality of different holographic patterns.

4. The master sheet of claim 1, further comprising:
a metallized layer adhered to the substrate, the metallized layer having the plurality of different holographic patterns.

5. The master sheet of claim 1, further comprising:
a print receptive coating atop the metallized layer.

6. The master sheet of claim 1, further comprising:
a first card corresponding to a first of the plurality of card positions; and
a second card corresponding to a second of the plurality of card positions;
wherein the first card and the second card have a same image and a different holographic pattern.

7. The master sheet of claim 1, further comprising:
at least one mark configured to be utilized by a digital printing device for registering images with the plurality of card positions.

8. A method of manufacturing trading cards, comprising the steps of:
adhering a metal layer to a substrate to form a master sheet, the metal layer including a plurality of different holograph patterns, including a first holographic pattern and a second holographic pattern, the first holographic pattern being different from the second holographic patter;
printing a first image over the first holographic pattern; and
printing a second image over the second holographic pattern.

9. The method according to claim 8, further comprising the step of:
cutting a first trading card from the master sheet, the first trading card having the first holographic pattern and the first image; and
cutting a second trading card from the master sheet, the second trading card having the second holographic pattern and the second image.

10. The method according to claim 8, wherein:
the first image and the second image are the same.

11. The method according to claim 8, wherein:
the first image and the second image are different.

12. The method according to claim 8, wherein:
the trading cards are sports trading cards.

13. A method of manufacturing trading cards, comprising:
providing a master sheet having a plurality of card positions arranged in a plurality of rows and a plurality of columns, at least one of the card positions having a different holographic pattern than the holographic pattern of another card position of the plurality of card positions;
printing an image on each card position of the plurality of card positions; and
cutting the master sheet at the boundaries of each card position to form a plurality of trading cards.

14. The method according to claim 13, wherein:
at least one row of the plurality of rows has a holographic pattern that is different from a holographic pattern of at least another row of the plurality of rows.

15. The method according to claim 13, wherein:
at least one column of the plurality of columns has a holographic pattern that is different from a holographic pattern of at least another column of the plurality of columns.

16. The method according to claim 13, further comprising the steps of:
adhering a metal layer to a substrate to form the master sheet, the metal layer including the plurality of different holograph patterns.

17. The method according to claim 13, wherein the step of printing an image on each card position of the plurality of card positions includes printing a first image atop a first holographic pattern and printing a second image atop the second holographic pattern;
wherein the first image and the second image are the same.

18. The method according to claim 13, wherein:
the plurality of trading cards are packaged according to a serial order of the plurality of trading cards on the master sheet.

19. The method according to claim 13, wherein:
a layout of the trading cards on the master sheet corresponds to a packaging order of the trading cards.

20. The method according to claim 13, further comprising the step of:
programming a image layout of the master sheet in dependence upon a particular holographic pattern and drop rate.
